(19) United States
(12) Patent Application Publication
(10) Pub. No.: US 2013/0037329 A1
(43) Pub. Date: Feb. 14, 2013

(54) Impurity Weight Measurement

(71) Applicants: Yazhou Liu, Suzhou (CN); Zibo Xu, Suzhou (CN); Xiaoli Yang, Suzhou (CN)

(72) Inventors: Yazhou Liu, Suzhou (CN); Zibo Xu, Suzhou (CN); Xiaoli Yang, Suzhou (CN)

(73) Assignee: USTER TECHNOLOGIES AG, Uster (CH)

(21) Appl. No.: 13/393,363

(22) PCT Filed: May 5, 2011
(86) PCT No.: PCT/CH2011/000106

§ 371 Date: Feb. 29, 2012

(30) Foreign Application Priority Data
May 6, 2010 (CN) 201010180707.7

(51) Int. Cl. G01G 19/00

(52) U.S. Cl. 177/1; 177/145

(57) ABSTRACT

An apparatus for measuring the weight of impurities in a cotton sample, with a double-taker-in-roll mechanism. The apparatus includes the following components: an air current channel, a fiber feeding device located at the front end of the air current channel; a primary taker-in cylinder located behind the fiber feeding construction; a stationary stripping device located near the surface of the primary taker-in cylinder; a secondary taker-in cylinder adjacent to the surface of the primary taker-in cylinder and located behind the primary taker-in cylinder; an impurity collecting apparatus located below the primary taker-in cylinder and the secondary taker-in cylinder; and an impurity measurement apparatus connected with the impurity collecting apparatus. After double impurity removal with the primary taker-in cylinder and the secondary taker-in cylinder, the impurities are removed from the cotton sample more completely compared with the prior single taker-in cylinder structure, making the impurity measurement value more accurate.

### FIELD

This application claims all rights and priority on prior pending patent applications PCT/CH2011/000106 filed May 5, 2011 and CN201010180707.7 filed May 6, 2010. The present invention relates to the field of fiber processing. More particularly, it relates to an apparatus and a method for measuring the weight of impurities in a mixed volume of fibers and impurities. Its preferred use is the measurement of the impurity content in raw cotton.

### BACKGROUND

Currently in the textile industry, it is usually necessary to measure the fiber impurity content in raw cotton. The impurity content means the ratio of undesired impurities such as sand, branches and leaves, boll hull, and soft seed skin in the fiber. For example, the impurity content of saw ginned cotton according to the Chinese National Standard is 2.5%. A raw cotton impurity analyzer is generally used in actual work to measure the raw-cotton impurity content. As the term is used herein, “impurities” refers to any non-primary-fiber material, such as husks, twigs, leaves, dirt, rocks, and any other non-primary-fiber material that might become mixed into the fiber volume. In other publications, the term “trash” is used as a synonym for “impurities.” In the case of cotton fibers for example, “impurities” refers to anything that isn't cotton fiber.

A test analysis instrument with a single taker-in cylinder mechanism, e.g. YG041, YG042, and Y101 as described in Chinese National Standard (GB/T0499) “Testing methods for the trash contents of raw cotton,” is adopted in all the traditional test methods for raw cotton impurity content. The typical structure of these traditional raw cotton impurity analyzers is the following: first there is a cotton feeding roller, behind which is a taker-in cylinder, along the circumference of which are installed two or more separation knives; then there is an air current channel for stripping and taking away the fibers on the surface of the taker-in cylinder; and below the separation knife is an impurity disk that is used for collecting impurities and can be taken out manually.

The mechanical impurity-separation principle applied in the known instruments is the following: after the raw cotton is rolled up by the cotton feeding roller and brought into contact with the taker-in cylinder. The taker-in cylinder rotates at a high speed and combs the raw cotton. The fibers and the impurities, being loosened after being combed by the sawtooth structure on the surface of the taker-in cylinder, adhere to the surface of the taker-in cylinder under the action of air current, and rotate at a high speed along with the taker-in cylinder. Due to the different shapes, masses and densities of the fibers and the impurities, under the combined action of the centrifugal force and the air current, the fibers adhere to the surface of the taker-in cylinder, while the impurities are floated in the air current layer farther away from the surface of the taker-in cylinder. When passing across the separation knife, the impurities are blocked and fall down to the impurity disk under the action of gravity, while the fibers continue to rotate with the taker-in cylinder. When the fibers continuing to rotate with the taker-in cylinder are brought into the air current channel tangent to the rotating direction of the taker-in cylinder, due to the pressure change resulting from the special shape of the air current channel, the fibers are detached from the surface of the taker-in cylinder, and taken away by the air current.

During the above-mentioned impurity separation process, under the action of machinery and air current, a small amount of fibers may inevitably be detached from the surface of the taker-in cylinder and fall onto the impurity disk. In the traditional impurity analytical apparatus, the weight content of impurities in the raw cotton can be obtained through manual picking and weighing of the fibers admixed to the impurities. This manual picking method will not only waste a great deal of manpower and time, but also its results show personal differences resulting from the personal picking, causing a deviation in the measured value.

The publication EP-0'533'079 A2 gives an example of an aeromechanical separation of impurities from fibers, as applied in the fiber-testing system USTER® AFIS PRO 2 from Uster Technologies AG, Uster, Switzerland. The weight of the mixed volume of fibers and impurities is measured by weighing on scales. Then the mixed volume is formed into a sliver, and the sliver is delivered to a first pinned separator wheel. A second pinned separator wheel is located below the first separator wheel. The separator wheels have each a radius of about 32 mm and rotate at very high speeds of 7000-8000 rpm (i.e., 117-133 s⁻¹). Due to the large centrifugal forces generated at such high rotational speeds, the impurities are centrifuged from the surfaces of the separator wheels into a counterflow of air. The counterflow air returns fibers back to the separator wheels, but is overcome by the impurities. The thus separated impurities are optically sensed by an optical sensor. A computer receives the weight data from the scales and the output signal from the optical sensor. It calculates the weight of the impurities from the accumulated projected area of the impurities. The fibers may be processed in the same way as the impurities. This method also suffers from the drawback that the mechanical separation may be incomplete.

In summary, the conventional analysis instruments and methods have shortcomings such as low efficiency and great labor load; besides, two analysis cycles on the test sample are generally required in the test analysis process, with the lower analysis efficiency; moreover, the separated impurities usually contain effective cotton fibers, which results in a deviation in the test result and requires manual picking, thus still resulting in a personal difference in the test result.

### SUMMARY

A purpose of the present invention is to provide an apparatus and a method for measuring the weight of impurities in a mixed volume of fibers and impurities, which not only increase efficiency and accuracy of the measurement to a great extent, but also reduce the labor load.

The above problem is solved by the apparatus and the method as defined in the independent claims. Additional embodiments are defined in the dependent claims.

The idea of the invention is to perform a multifold separation of the fibers and the impurities. This is achieved by at least two taker-in cylinders located in the air current, which are arranged so close to each other that part of the fibers and impurities is passed over from a precedent taker-in cylinder to the subsequent taker-in cylinder. On each taker-in cylinder, the impurities are separated from the fibers by a combined action of gravity, centrifugal force, the air current and mechanical stripping. Additional separations of the impurities from the fibers take place between two adjacent taker-in cylinders, when part of the fibers and impurities is passed over from one taker-in cylinder to the next. Thus, a more complete removal of impurities from the mixed volume is performed, resulting in a higher measurement accuracy.

Accordingly, one embodiment of the apparatus for measuring the weight of impurities in a mixed volume of fibers and impurities comprises an air current channel, a fiber feeding device located at a front end of the air current channel, a primary taker-in cylinder located in the air current channel behind the fiber feeding device, and at least one stationary stripping device located near the surface of the primary taker-in cylinder. A secondary taker-in cylinder is located in the air current channel behind the primary taker-in cylinder, surfaces of the primary taker-in cylinder and the secondary taker-in cylinder being adjacent to each other. An impurity collecting apparatus is located below the primary taker-in cylinder and the secondary taker-in cylinder. An impurity measurement apparatus is connected with the impurity collecting apparatus.

The primary taker-in cylinder and the secondary taker-in cylinder are mutually arranged such that part of the mixed volume is transferrable from the primary taker-in cylinder to the secondary taker-in cylinder. In one embodiment, the minimum distance between the surfaces of the taker-in cylinders is between 0.1 and 1 mm, such as 0.25 mm. The primary taker-in cylinder of one embodiment has a diameter of 20-30 cm, such as 25 cm, and the secondary taker-in cylinder has a diameter of 10-20 cm, such as 16 cm.

In some embodiments, the apparatus comprises a drive mechanism for the primary taker-in cylinder, which drive mechanism is adapted for driving the primary taker-in cylinder at a rotational speed of 1300-1700 rpm (21.7-28.3 s⁻¹), such as 1500 rpm (25.0 s⁻¹). Likewise, the apparatus comprises a drive mechanism for the secondary taker-in cylinder, which drive mechanism is adapted for driving the secondary taker-in cylinder at a rotational speed of 900-1200 rpm (15.0-20.0 s⁻¹), such as 1050 rpm (17.5 s⁻¹). At least one of primary taker-in cylinder and the secondary taker-in cylinder has a width in axial direction of 30-70 cm, such as 50 cm. The surface of at least one of the primary taker-in cylinder and the secondary taker-in cylinder bears a serrated structure or sawtooth structure. Such serrated surfaces are more aggressive than the pinned surfaces known from the prior art, and thus more effectively separate the impurities from the fibers. A potential damaging of the fibers is irrelevant in the present application. The height of the serrated structure may be 1-4 mm, such as 2.5 mm.

The apparatus according to this embodiment of the invention is thus able to process 30 grams of sample per minute, whereas the apparatus according to EP-0'533'079 A2 processes only 0.25 grams per minute. The high processing capacity makes the apparatus according to the invention suitable for high-volume fiber processing.

At least one additional stationary stripping device may be located near the surface of the secondary taker-in cylinder. The distance between the at least one stripping device and the surface of the respective taker-in cylinder is between 0.1 mm and 1 mm, such as between 0.2 and 0.6 mm.

The fiber feeding device of one embodiment includes a fiber feeding roller and a fiber feeding plate. The impurity measurement apparatus in some embodiments includes an electronic scale or balance arranged below the impurity collecting apparatus.

The embodiments of the invention can be generalized to comprise a number of taker-in cylinders higher than two. In general, the embodiments of the apparatus according to the invention comprises N taker-in cylinders arranged consecutively adjacent to each other, N being a positive integer bigger than or equal to 2, all N taker-in cylinders having the same rotational direction.

According to a method embodiment for measuring the weight of impurities in a mixed volume of fibers and impurities, an air current is provided. The mixed volume is fed onto a surface of a rotating primary taker-in cylinder located in the air current. The impurities are mechanically striped off from the fibers on the primary taker-in cylinder. Part of the mixed volume is transferred from the primary taker-in cylinder to a secondary taker-in cylinder located in the air current. The impurities are separated from the fibers on the secondary taker-in cylinder. The impurities separated on the primary taker-in cylinder and the secondary taker-in cylinder are collected. The collected impurities are weighed.

The separation of the impurities from the fibers on the primary taker-in cylinder and the secondary taker-in cylinder may make use of the action of centrifugal force, gravity, the air current and mechanical stripping.

In one embodiment, the primary taker-in cylinder has a diameter of 20-30 cm, such as 25 cm, and the secondary taker-in cylinder has a diameter of 10-20 cm, such as 16 cm. The primary taker-in cylinder rotates at a rotational speed of 1300-1700 rpm (21.7-28.3 s⁻¹), such as 1500 rpm (25.0 s⁻¹). The secondary taker-in cylinder rotates at a rotational speed of 900-1200 rpm (15.0-20.0 s⁻¹), such as 1050 rpm (17.5 s⁻¹). The primary taker-in cylinder has a surface linear velocity of 15-25 m/s, such as 19.7 m/s, and the secondary taker-in cylinder has a surface linear velocity of 5-12 m/s, such as 8.7 m/s. The centrifugal acceleration on the surface of the primary taker-in cylinder is 1860-4740 m/s², such as 3090 m/s², and the centrifugal acceleration on the surface of the secondary taker-in cylinder is 444-1580 m/s², such as 967 m/s². These preferred centrifugal accelerations are clearly lower than those on the surfaces of the separator wheels as described in EP-0'533'079 A2, where mechanical stripping devices are not used.

In some embodiments the surface of at least one of the primary taker-in cylinder and the secondary taker-in cylinder bears a serrated structure or sawtooth structure. The primary taker-in cylinder and the secondary taker-in cylinder may have the same rotational direction.

In one embodiment, the air current below the taker-in cylinders has essentially a horizontal direction. Such a horizontal air current acts like a sheet of air that carries away fibers detached from the taker-in cylinders. The impurities, which are heavier than the fibers, fall through this sheet of air under the action of gravity.

Part of the mixed volume may be transferred from the secondary taker-in cylinder to a further taker-in cylinder located in the air current, all taker-in cylinders having the same rotational direction.

The beneficial effects of the embodiments of the present invention are the following: the present embodiments, after a double impurity removal with the primary taker-in cylinder and the secondary taker-in cylinder, remove the impurities from the cotton sample more completely compared to the prior-art single taker-in cylinder structure, making the subsequent impurity measurement value more accurate. Therefore, efficiency and accuracy of the measurement is increased significantly.

### DRAWINGS

An embodiment of the present invention is further described below in detail with reference to the drawings.

FIG. 1 is a schematic drawing of the impurity separation section of the apparatus according to an embodiment the invention.

FIG. 2 is a schematic drawing of the impurity measurement section of the apparatus according to an embodiment the invention.

FIG. 3 is a schematic front view of part of a taker-in cylinder included in the apparatus according to an embodiment the invention.

### DESCRIPTION

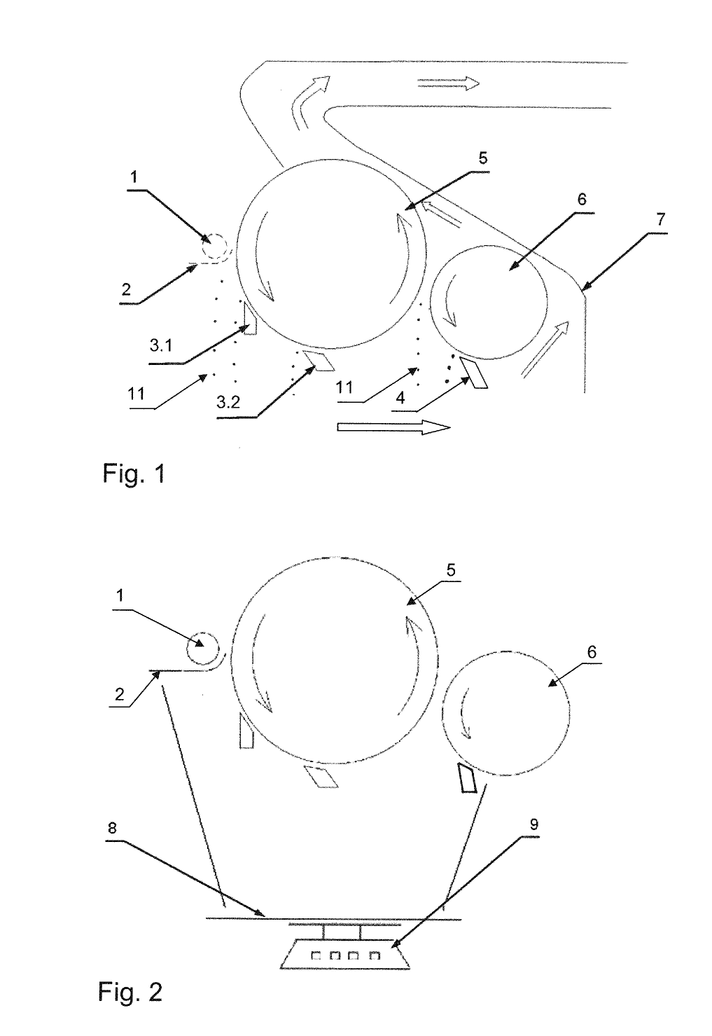

The apparatus according to the described embodiment of the invention adopts the double taker-in cylinder mechanism, which, as depicted in FIGS. 1 and 2, mainly includes a fiber feeding roller 1, a fiber feeding plate 2, primary separation knives 3.1, 3.2, a secondary separation knife 4, a primary taker-in cylinder 5, a secondary taker-in cylinder 6, an air current guide 7, an impurity disk 8, and a gravimetric device such as an electronic scale or balance 9.

As shown in FIG. 1, the apparatus according to the present embodiment includes an air current channel, which comprises the air current guide 7. The directions of the air current at various locations are indicated by arrows. The air current below the taker-in cylinders 5, 6 has an essentially horizontal direction. At an entrance section of the air current channel is provided a fiber feeding device comprising the fiber feeding roller 1 and the fiber feeding plate 2, the fiber feeding roller 1 feeding the raw cotton sample (not shown) that needs an impurity test. The raw cotton sample, gripped by the fiber feeding roller 1 and the fiber feeding plate 2, is combed by the primary taker-in cylinder 5. The impurity disk 8 is positioned below the primary taker-in cylinder 5. The black dots shown in FIG. 1 indicate the impurities 11 that are combed out, some of the impurities 11 falling downwards to the impurity disk 8 under the combined action of gravity and centrifugal force, other impurities moving with the taker-in cylinder 5 under the action of air current.

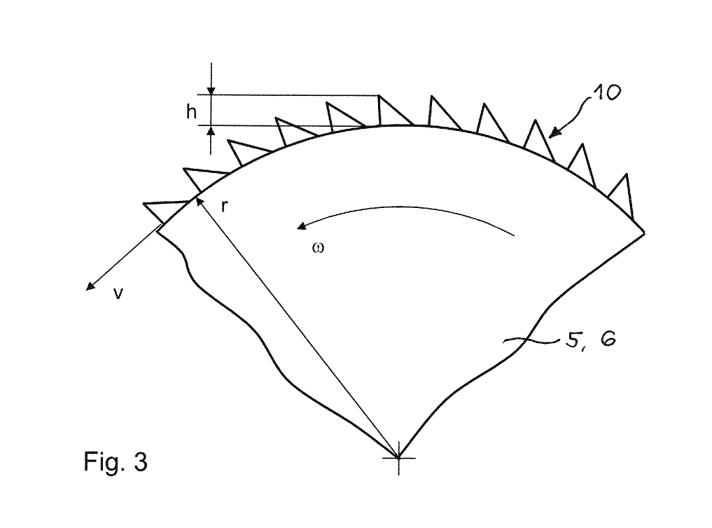

The primary separation knives 3.1, 3.2 are positioned in a stationary manner along and near the surface of the primary taker-in cylinder 5. The above-mentioned impurities adhering to the taker-in cylinder 5, when passing across the primary separation knives 3.1, 3.2, are blocked by the separation knives 3.1, 3.2 and fall down to the impurity disk 8. Thus, the separation knives 3.1, 3.2 act as stripping devices that strip off or comb out the impurities. There are one or more such separation knives 3.1, 3.2, the amount being determined as required. The linear surface velocity v (see FIG. 3) of the primary taker-in cylinder 5 according to the invention is significantly higher, e.g., nearly twice as high, than that of the taker-in cylinder in a traditional analytical apparatus. In some embodiments it is within the range of 15-25 m/s, in some embodiments 17.7-21.7 m/s, and in some embodiments 19.7 m/s.

According to some embodiments of the present invention, behind the primary taker-in cylinder 5 is positioned the secondary taker-in cylinder 6, whose surface is near but not in direct contact with the surface of the primary taker-in cylinder 5. The secondary taker-in cylinder 6 rotates more slowly than the primary taker-in cylinder 5; its linear surface velocity v in some embodiments is within 5-15 m/s, in some embodiments 7.5-9.9 m/s, and in some embodiments 8.7 m/s. The secondary taker-in cylinder 6 has the same rotational direction as the primary taker-in cylinder 5. In the region where the surfaces of the taker-in cylinders 5, 6 have minimum distance, the surface speed vectors of the taker-in cylinders 5, 6 are opposed to each other and the relative linear surface velocity equals the sum of the two velocities. The fibers are transferred from the primary taker-in cylinder 5 to the secondary taker-in cylinder 6.

The cotton fibers, after being combed, are attached to the surface of the primary taker-in cylinder 5 and move with it and, when passing the region where the surfaces of the taker-in cylinders 5, 6 have minimum distance, are combed again by the secondary taker-in cylinder 6. Thus, impurities not combed out by the separation knives 3.1, 3.2 are combed out by the secondary taker-in cylinder 6. In addition, a secondary separation knife 4 may be assigned to the secondary taker-in cylinder 6; the secondary separation knife 4 and the secondary taker-in cylinder 6 cooperate as described for the primary separation knives 3.1, 3.2 and the primary taker-in cylinder 5 in order to strip off the remaining impurities. As mentioned above, the impurities 11 fall to the impurity disk 8 under the action of gravity and centrifugal force. Thus, the embodiments of the invention, after double impurity removal with the primary taker-in cylinder 5 and the secondary taker-in cylinder 6, remove the impurities from the cotton sample more completely compared to the prior-art single taker-in cylinder structure, making the subsequent impurity measurement value closer to the actual value.

The cotton fibers, on the other hand, continue to rotate with the taker-in cylinders 5, 6. When the air current is tangent to the surface-velocity vector of the respective taker-in cylinder 5, 6, they experience a pressure drop. The fibers are then detached from the surface of the respective taker-in cylinder 5, 6, and taken away by the air current.

The secondary taker-in cylinder 6 can be designed to have the same structure as the primary taker-in cylinder 5. For example, two or more separation knives, the amount being determined as required, can be positioned along the surface of the secondary taker-in cylinder 6.

The primary taker-in cylinder 5 has a diameter 2r (see FIG. 3) in some embodiments of 20-30 cm, in some embodiments 25 cm, and the secondary taker-in cylinder 6 in some embodiments has a diameter 2r of 10-20 cm, in some embodiments 16 cm. The widths in axial direction of the taker-in cylinders 5, 6 in some embodiments are 30-70 cm, in some embodiments 50 cm. The minimum distance between the surfaces of the taker-in cylinders 5, 6 in some embodiments is between 0.1 and 1 mm, in some embodiments 0.25 mm. The distance between each of the separation knives 3.1, 3.2, 4 and the surface of the primary taker-in cylinder in some embodiments is between 0.1 and 1 mm, and in some embodiments between 0.2 mm and 0.6 mm.

As shown in FIG. 2, the impurity disk 8 is big enough such that all the impurities 11 separated from the taker-in cylinders 5, 6 are collected on the impurity disk 8. The electronic scale 9 is positioned below the impurity disk 8 and in some embodiments connected with it. The impurities 11, falling to the impurity disk 8 when passing across the primary taker-in cylinder 5 and the secondary taker-in cylinder 6, can be weighed automatically by the electronic scale 9 after sample completion.

The embodiments of the present invention can be applied to the impurity measurement in raw cotton and other fiber products. The embodiment discussed above has a primary taker-in cylinder 5 and a secondary taker-in cylinder 6. Depending on the actual application, based on the conception of the embodiments of the present invention, a third taker-in cylinder, a fourth taker-in cylinder and so on can be provided, with their surfaces consecutively near to each other and their structure being similar to that according to the embodiment discussed above. The total number N of taker-in cylinders is a positive integer bigger than or equal to 2.

The fibers, after being combed by the primary taker-in cylinder 5, can be combed again by the secondary taker-in cylinder 6 according to the embodiments of the invention, which can comb out more impurities that are not combed out during the first impurity removal process. For example, the apparatus according to the above embodiment of the invention can complete the impurity weight content analysis of a 30-gram raw cotton sample within one minute. Its efficiency is increased by a factor of 3.5 compared with the traditional raw cotton impurity content analysis instruments. Meanwhile, with the introduction of a camera system, the analysis accuracy of raw cotton impurity content is increased to a great extent, and the labor load reduced at the same time.

FIG. 3 shows a schematic front view, not to scale, of part of the taker-in cylinder 5 or 6. The radius r of the taker-in cylinder 5, 6 in some embodiments is in the range between 5 and 15 cm. The surface of the taker-in cylinder 5, 6 bears a serrated structure 10 built up, e.g., of a sequence of saw teeth equally distributed along the circumference of the taker-in cylinder 5, 6. The height h of the serrated structure in some embodiments is in the range between 1 and 4 mm, i.e., the ratio of the height h and the radius r is in the range between 0.7% and 8%. The serrated structure 10 extends over essentially the whole width of the taker-in cylinder 5, 6. This may be realized by a serrated band that wraps the lateral area of the cylinder 5, 6 in the form of a helical curve. The angular speed ω of the taker-in cylinder 5, 6 in some embodiments is in the range between 94.3 rad/s and 178 rad/s. The surface velocity v can be calculated according to the formula:

v=ωr,

and the centrifugal acceleration a is given by the formula:

a=ω²r.

The present invention is not limited to the embodiments discussed above. The description of the embodiment above is only for describing and explaining the technical solution involved in the invention. An obvious transformation and substitution based on the present invention should also be thought to be within the scope of protection of the invention. The embodiments above are used so as to enable those skilled in the art to achieve the purpose of the present invention by using various embodiments and various substitute methods.

### REFERENCES

1 Fiber feeding roller

2 Fiber feeding plate

3.1, 3.2 Primary separation knives

4 Secondary separation knife

5 Primary taker-in cylinder

6 Secondary taker-in cylinder

7 Air current guide

8 Impurity disk

9 Electronic scale

10 Serrated structure

11 Impurities

h Height of the serrated structure

r Radius of the taker-in cylinder

v Surface linear velocity of the taker-in cylinder

ω Rotational speed of the taker-in cylinder

1. An apparatus for measuring the weight of impurities in a mixed volume of fibers and impurities, comprising
an air current channel,
a fiber feeding device (1, 2) located at a front end of the air current channel,
a primary taker-in cylinder (5) located in the air current channel behind the fiber feeding device (1, 2), and
at least one stationary stripping device (3.1, 3.2) is located near the surface of the primary taker-in cylinder (5),
characterized in that
a secondary taker-in cylinder (6) is located in the air current channel behind the primary taker-in cylinder (5), surfaces of the primary taker-in cylinder (5) and the secondary taker-in cylinder (6) being adjacent to each other,
an impurity collecting apparatus (8) is located below the primary taker-in cylinder (5) and the secondary taker-in cylinder (6), and
an impurity measurement apparatus (9) is connected with the impurity collecting apparatus (8).

2. The apparatus according to claim 1, wherein the primary taker-in cylinder (5) and the secondary taker-in cylinder (6) are mutually arranged such that part of the mixed volume is transferrable from the primary taker-in cylinder (5) to the secondary taker-in cylinder (6).

3. The apparatus according to any of the preceding claims, wherein the minimum distance between the surfaces of the taker-in cylinders (5, 6) is between 0.1 and 1 mm, preferably 0.25 mm.

4. The apparatus according to any of the preceding claims, wherein the primary taker-in cylinder (5) has a diameter (2r) of 20-30 cm, preferably 25 cm, and the secondary taker-in cylinder (6) has a diameter (2r) of 10-20 cm, preferably 16 cm.

5. The apparatus according to any of the preceding claims, wherein the apparatus comprises a drive mechanism for the primary taker-in cylinder (5), which drive mechanism is adapted for driving the primary taker-in cylinder (5) at a rotational speed (ω/(2π)) of 1300-1700 rpm (21.7-28.3 s⁻¹), and preferably 1500 rpm (25.0 s⁻¹), and the apparatus comprises a drive mechanism for the secondary taker-in cylinder (6), which drive mechanism is adapted for driving the secondary taker-in cylinder (6) at a rotational speed (ω/(2π)) of 900-1200 rpm (15.0-20.0 s⁻¹), and preferably 1050 rpm (17.5 s⁻¹).

6. The apparatus according to any of the preceding claims, wherein the primary taker-in cylinder (5) and/or the secondary taker-in cylinder (6) has a width in axial direction of 30-70 cm, preferably 50 cm.

7. The apparatus according to any of the preceding claims, wherein the surface of the primary taker-in cylinder (5) and/or the secondary taker-in cylinder (6) bears a serrated structure (10).

8. The apparatus according to claim 7, wherein the height (h) of the serrated structure (10) is 1-4 mm, preferably 2.5 mm.

9. The apparatus according to any of the preceding claims, wherein at least one additional stationary stripping device (4) is located near the surface of the secondary taker-in cylinder (6).

10. The apparatus according any of the preceding claims, wherein the distance between the at least one stripping device (3.1, 3.2, 4) and the surface of the respective taker-in cylinder (5, 6) is between 0.1 mm and 1 mm, and preferably between 0.2 mm and 0.6 mm.

11. The apparatus according to any of the preceding claims, wherein the fiber feeding device (1, 2) includes a fiber feeding roller (1) and a fiber feeding plate (2).

12. The apparatus according to any of the preceding claims, wherein the impurity measurement apparatus includes an electronic scale (9) arranged below the impurity collecting apparatus (8).

13. The apparatus according to any of the preceding claims, comprising N taker-in cylinders (5, 6) arranged consecutively adjacent to each other, N being a positive integer bigger than or equal to 2, all N taker-in cylinders (5, 6) having the same rotational direction.

14. A method for measuring the weight of impurities in a mixed volume of fibers and impurities, comprising the steps of:
providing an air current, p1 feeding the mixed volume onto a surface of a rotating primary taker-in cylinder (5) located in the air current,
mechanically striping off the impurities (11) from the primary taker-in cylinder (5),
characterized in that
part of the mixed volume is transferred from the primary taker-in cylinder (5) to a secondary taker-in cylinder (6) located in the air current,
the impurities (11) are separated from the fibers on the secondary taker-in cylinder (6),
impurities (11) separated on the primary taker-in cylinder (5) and the secondary taker-in cylinder (6) are collected, and
the collected impurities (11) are weighed.

15. The method according to claim 14, wherein the primary taker-in cylinder (5) has a diameter (2r) of 20-30 cm, preferably 25 cm, and the secondary taker-in cylinder (6) has a diameter (2r) of 10-20 cm, preferably 16 cm.

16. The method according to claim 14 or 15, wherein the primary taker-in cylinder (5) rotates at a rotational speed (ω/(2π)) of 1300-1700 rpm (21.7-28.3 s⁻¹), and preferably 1500 rpm (25.0 s⁻¹).

17. The method according to any of the claims 14-16, wherein the secondary taker-in cylinder (6) rotates at a rotational speed (ω/(2π)) of 900-1200 rpm (15.0-20.0 s⁻¹), and preferably 1050 rpm (17.5 s⁻¹ ).

18. The method according to any of the claims 14-17, wherein the primary taker-in cylinder (5) has a surface linear velocity (v) of 15-25 m/s, preferably 19.7 m/s, and the secondary taker-in cylinder (6) has a surface linear velocity (v) of 5-12 m/s, preferably 8.7 m/s.

19. The method according to any of the claims 14-18, wherein the centrifugal acceleration on the surface of the primary taker-in cylinder (5) is 1860-4740 m/s², preferably 3090 m/s², and the centrifugal acceleration on the surface of the secondary taker-in cylinder (6) is 444-1580 m/s², preferably 967 m/s².

20. The method according to any of the claims 14-19, wherein the surface of the primary taker-in cylinder (5) and/or the secondary taker-in cylinder (6) bears a serrated structure (10).

21. The method according to any of the claims 14-20, wherein the primary taker-in cylinder (5) and the secondary taker-in cylinder (6) have the same rotational direction.

22. The method according to any of the claims 14-21, wherein the air current below the taker-in cylinders (5, 6) has essentially a horizontal direction.

23. The method according to any of the claims 14-22, wherein part of the mixed volume is transferred from the secondary taker-in cylinder (6) to a further taker-in cylinder located in the air current, all taker-in cylinders (5, 6) having the same rotational direction.
